(19) United States
(12) Patent Application Publication
(10) Pub. No.: US 2008/0216867 A1
(43) Pub. Date: Sep. 11, 2008

(54) Methods and apparatus for cleaning an edge of a substrate

(75) Inventors: Wei-Yung Hsu, (US); Donald J. K. Olgado, (US); Ho Seon Shin, (US); Liang-Yuh Chen, (US)

Correspondence Address: DUGAN & DUGAN, PC, 245 Saw Mill River Road, Suite 309, Hawthorne, NY, 10532, US

(73) Assignee: APPLIED MATERIALS, INC.

(21) Appl. No.: 11/411,215

(22) Filed: Apr. 24, 2006

Related U.S. Application Data
(60) Provisional application No. 60/674,910, filed on Apr. 25, 2005.

(51) Int. Cl. B08B 7/00

(52) U.S. Cl. 134/6

(57) ABSTRACT

In one aspect, an apparatus for cleaning an edge of a substrate is provided. The apparatus includes (1) one or more rollers of a first diameter adapted to contact an edge of a substrate and rotate the substrate; and (2) one or more rollers of a second diameter that is larger than the first diameter adapted to contact an edge of the substrate and to clean the edge of the substrate. The one or more rollers of the first diameter and the one or more rollers of the second diameter may be adapted to rotate at substantially the same speed. Numerous other aspects are provided.

The present application claims priority from U.S. Provisional Patent Application Ser. No. 60/674,910, filed Apr. 25, 2005, which is hereby incorporated by reference herein in its entirety.

### CROSS REFERENCE TO RELATED APPLICATION

The present application is related to U.S. patent application Ser. No. ______, filed Apr. 24, 2006 and titled “METHODS AND APPARATUS FOR CLEANING AN EDGE OF A SUBSTRATE” (Attorney Docket No. 9861-02), which is hereby incorporated by reference herein in its entirety.

### FIELD OF THE INVENTION

The present invention relates to semiconductor device fabrication, and more particularly to methods and apparatus for cleaning an edge of a substrate.

### BACKGROUND OF THE INVENTION

After chemical mechanical polishing, slurry residue conventionally is cleaned or scrubbed from substrate surfaces via a mechanical scrubbing device, such as a device which employs polyvinyl acetate (PVA) brushes, brushes made from other porous or sponge-like material, or brushes having bristles made from nylon or similar materials. Although these conventional cleaning devices may remove a substantial portion of the slurry residue which adheres to the edges of a substrate, slurry particles as well as photoresist or other pre-deposited and/or pre-formed layers nonetheless may remain and produce defects during subsequent processing.

Accordingly a need exists within the field of substrate cleaning for methods and apparatus which effectively clean the edge surfaces of a substrate.

### SUMMARY OF THE INVENTION

In a first aspect of the invention, a first apparatus for cleaning an edge of a substrate is provided. The first apparatus includes (1) a substrate support adapted to support and rotate a substrate; and (2) one or more rollers positioned to contact an edge of a substrate supported by the substrate support. The one or more rollers are adapted to clean the edge of the substrate as the substrate support rotates the substrate relative to the one or more rollers.

In a second aspect of the invention, a second apparatus for cleaning an edge of a substrate is provided. The second apparatus includes (1) one or more rollers of a first diameter adapted to contact an edge of a substrate and rotate the substrate; and (2) one or more rollers of a second diameter that is larger than the first diameter adapted to contact the edge of the substrate and to clean the edge of the substrate. The one or more rollers of the first diameter and the one or more rollers of the second diameter may be adapted to rotate at substantially the same speed. Numerous other aspects are provided.

Other features and aspects of the present invention will become more fully apparent from the following detailed description, the appended claims and the accompanying drawings.

### BRIEF DESCRIPTION OF THE DRAWINGS

FIGS. 1A and 1B illustrate a top view and a side view, respectively, of a first exemplary edge cleaning apparatus provided in accordance with the present invention.

FIG. 1C is a front view of the first edge cleaning apparatus in which a single motor drives each roller.

FIG. 2A is a side view of a substrate showing a beveled edge region of the substrate and one or more rollers configured to clean the same in accordance with the present invention.

FIG. 2B is a side view of a roller having a flat surface for contacting a substrate in accordance with the present invention.

FIG. 2C is a side view of a roller having a grooved surface for contacting a substrate in accordance with the present invention.

FIG. 3A illustrates a top view of a roller in contact with a substrate during cleaning wherein the substrate and roller rotate in the same direction.

FIG. 3B illustrates a top view of a roller in contact with a substrate during cleaning wherein the substrate and roller rotate in opposite directions.

FIGS. 4A and 4B illustrate a top view and a side view, respectively, of a second exemplary edge cleaning apparatus provided in accordance with the present invention.

FIG. 4C is a front view of the second edge cleaning apparatus in which a single motor drives each roller.

FIG. 5 is top view of an embodiment in which the second cleaning apparatus employs two drive rollers and two cleaning rollers.

FIG. 6 is a top plan view of an exemplary embodiment of a planarization system provided in accordance with the present invention.

### DETAILED DESCRIPTION

In accordance with the present invention, one or more rollers may be employed to clean an edge of a substrate. Rotation of the substrate is independent and/or decoupled from edge cleaning. For example, in one embodiment of the invention, a substrate support stage is employed to support and rotate a substrate relative to one or more rollers so that the one or more rollers clean the edge of the substrate. In such an embodiment, each roller may be driven by the same motor to reduce cost and simplify implementation. Alternatively, a separate motor may be employed to rotate each roller.

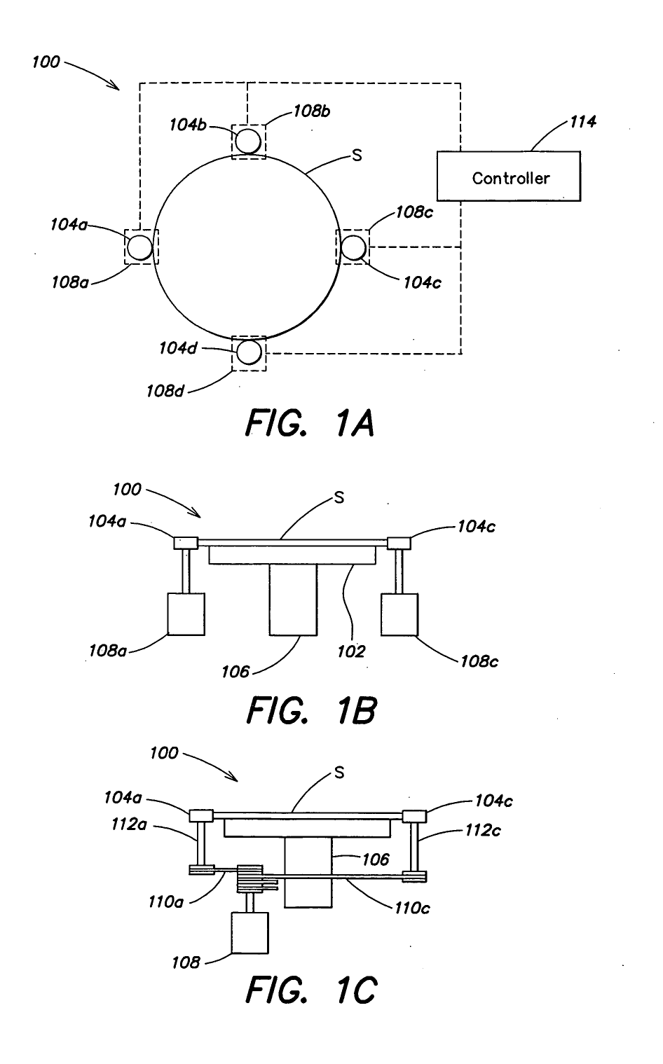

In a second embodiment of the invention, a substrate is rotated by one or more rollers of a first diameter, and cleaned by one or more rollers of a second, large diameter. As with the first embodiment of the invention, each roller may be driven by the same motor to reduce cost and simplify implementation. Alternatively, a separate motor may be employed to rotate each roller. These and other embodiments of the invention are described below with reference to FIGS. 1A-6.

FIGS. 1A and 1B illustrate a top view and a side view, respectively, of a first exemplary edge cleaning apparatus 100 provided in accordance with the present invention. With reference to FIGS. 1A and 1B, the first edge cleaning apparatus 100 includes a substrate support 102 (FIG. 1B) adapted to support and rotate a substrate S, and a plurality of rollers 104a-d positioned to contact and clean an edge of the substrate S (as described further below). While four rollers 104a-d are shown in FIGS. 1A-1B, it will be understood that fewer or more rollers may be used (e.g., 1, 2, 3, 5, 6, etc., rollers).

In the embodiment of FIGS. 1A and 1B, the substrate support 102 is rotated/driven by a first motor 106 and the rollers 104a-d are each rotated/driven by a separate motor 108a-d. In another embodiment, each of the rollers 104a-d may be driven by the same motor. For example, FIG. 1C is a front view of the first edge cleaning apparatus 100 in which a single motor 108 drives each roller 104a-d (via a plurality of belts 110a-d coupled to respective shafts 112a-d of each roller 104a-d, only two of which are shown in FIG. 1C). Note that such an implementation is less expensive and easier to implement. The substrate support 102 also may be driven by the motor 108 via appropriate belts and/or gearing.

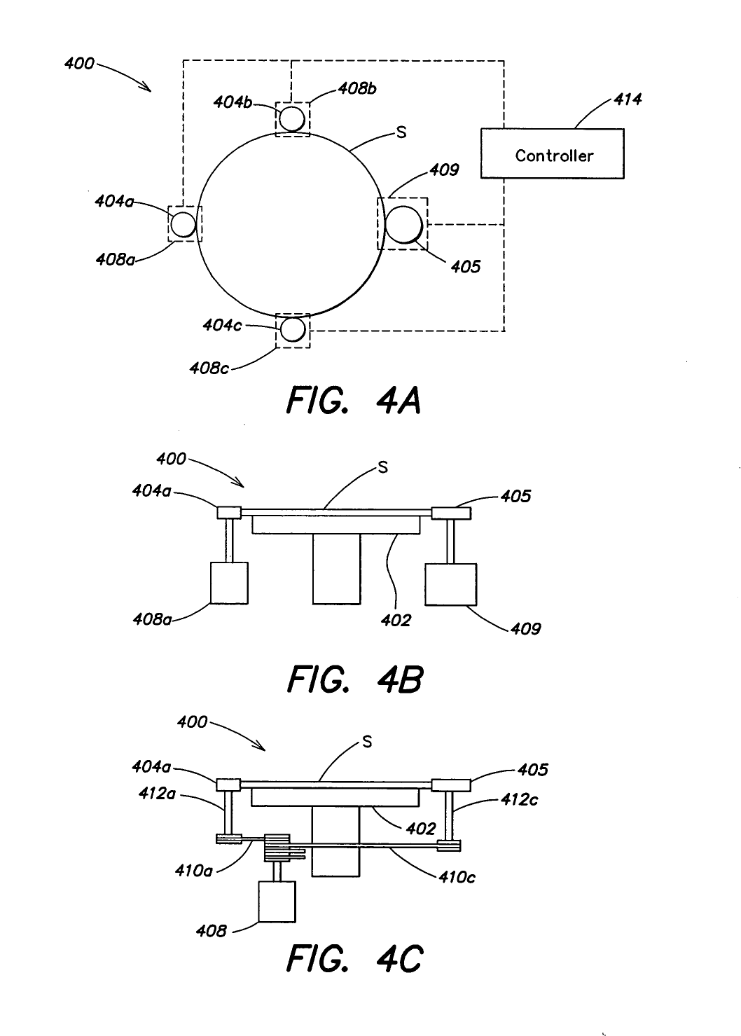

With reference again to FIGS. 1A-1C, the first edge cleaning apparatus 100 may include a controller 114 that is adapted to control operation of the first edge cleaning apparatus 100. For example, the controller 114 may be coupled to the first motor 106 and the motors 108a-d (or the motor 108 in the embodiment of FIG. 4C) and direct rotation of the substrate support 102 and rollers 104a-d as described further below. The controller 114 may include one or more microprocessors, microcontrollers, logic circuitry, a combination of the same, or any suitable hardware and/or software for controlling operation of the first edge cleaning apparatus 100.

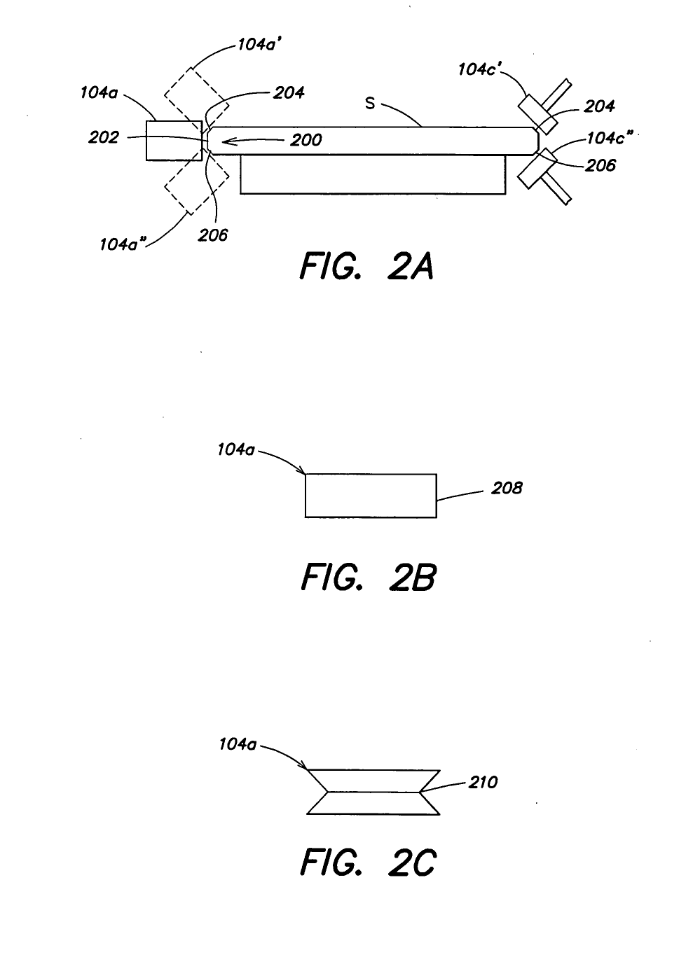

In at least one embodiment of the invention, the rollers 104a-d may be adapted to move along the edge of the substrate S to more effectively clean the substrate S. For example, FIG. 2A is a side view of the substrate S showing a beveled edge region 200 of the substrate S. As shown in FIG. 2A, the roller 104a is adapted to pivot from contact with the outer edge 202 of the substrate S into contact with a top bevel 204 of the substrate S or into contact with a bottom bevel 206 of the substrate S (as indicated by reference numerals 104a′ and 104a″, respectively). The rollers 104b-c may be similarly configured.

As further shown in FIG. 2A, one or more stationary rollers may be positioned so as to clean the top bevel 204 of the substrate S and/or the bottom bevel 206 of the substrate S as indicated by rollers 104c′, 104c″. In one embodiment, at least one roller may be positioned similar to roller 104a in FIG. 2A to clean an outer edge of the substrate S, at least one roller may be positioned similar to roller 104c′ in FIG. 2A to clean a top bevel of the substrate S and at least one roller may be positioned similar to roller 104c″ in FIG. 2A to clean a bottom bevel of the substrate S.

Each roller 104a-d may have any shape suitable for cleaning the edge region 200 of the substrate S. For example, FIG. 2B is a side view of a roller 104a having a flat surface 208 for contacting the substrate S; and FIG. 2C is a side view of a roller 104a having a grooved surface 210 for contacting the substrate S. The flat surface 208 may be more effective at cleaning the outer edge 202 (FIG. 2A) of the substrate S, while the grooved surface 210 may be more effective at cleaning the beveled edges 204, 206 of the substrate S. Any other roller shapes may be used for the rollers 104a-d, as may combinations of roller shapes.

The rollers 104a-d may be formed from any material that effectively cleans the edge of the substrate S. For example, if a cleaning chemistry is to be employed during edge cleaning, a soft roller material such as polyvinyl acetate (PVA) or the like may be used for one or more of the rollers 104a-d. However, if edge cleaning is to be predominately friction based (e.g., polishing), a harder roller material such as a fixed abrasive (e.g., a diamond impregnated polymer or metal matrix or another fixed abrasive), silicon carbide, etc., may be used for one or more of the rollers 104a-d.

In at least one embodiment of the invention, the drive rollers 104a-d have a diameter of about 1-5 inches. Other roller sizes may be used.

In operation, to clean the edge of the substrate S, the substrate S is placed on the substrate support 102 as shown in FIGS. 1A-1C. For example, the substrate S may be held against the substrate support 102 by vacuum, an electrostatic potential or by any other suitable chucking technique. Note that the rollers 104a-d may be retracted during placement of the substrate S onto the substrate support 102, and then brought into contact with the substrate S (as shown). The controller 114 may be adapted to control substrate placement and/or retraction of the rollers 104a-d.

Once the substrate S has been placed on and held by the substrate support 102, the controller 114 may direct the motor 106 to rotate the substrate S. Such rotation may occur before, during or after the rollers 104a-d contact the substrate S. In one embodiment, a substrate rotation rate of about 5 to 100 rotations per minute (RPM), and in one embodiment about 50 RPM, may be used for a 300 mm substrate. Other rotation rates may be used.

Before, during or after the substrate S begins to rotate, the controller 114 may direct the motors 108a-d (or the motor 108 in FIG. 1C) to rotate each roller 104a-d. In one embodiment, a roller rotation rate of about 1 to 500 rotations per minute (RPM) may be used for a 300 mm substrate. Other rotation rates may be used. In at least one embodiment, a positive pressure, such as less than about 20 psi, may be exerted against the substrate S by the rollers 104a-d. Other pressures may be used.

The rotation rates and/or directions of the substrate S and the rollers 104a-d are selected such that at the point (or points) of contact between each roller 104a-d and the substrate S, each roller 104a-d and the substrate S have a different tangential velocity. In this manner, sliding contact occurs between each roller 104a-d and the substrate S, and the edge of the substrate S is cleaned (e.g., by mechanical polishing or by chemically assisted polishing if a cleaning chemistry is employed). Cleaning may continue until any material to be removed from the edge of the substrate S has been removed.

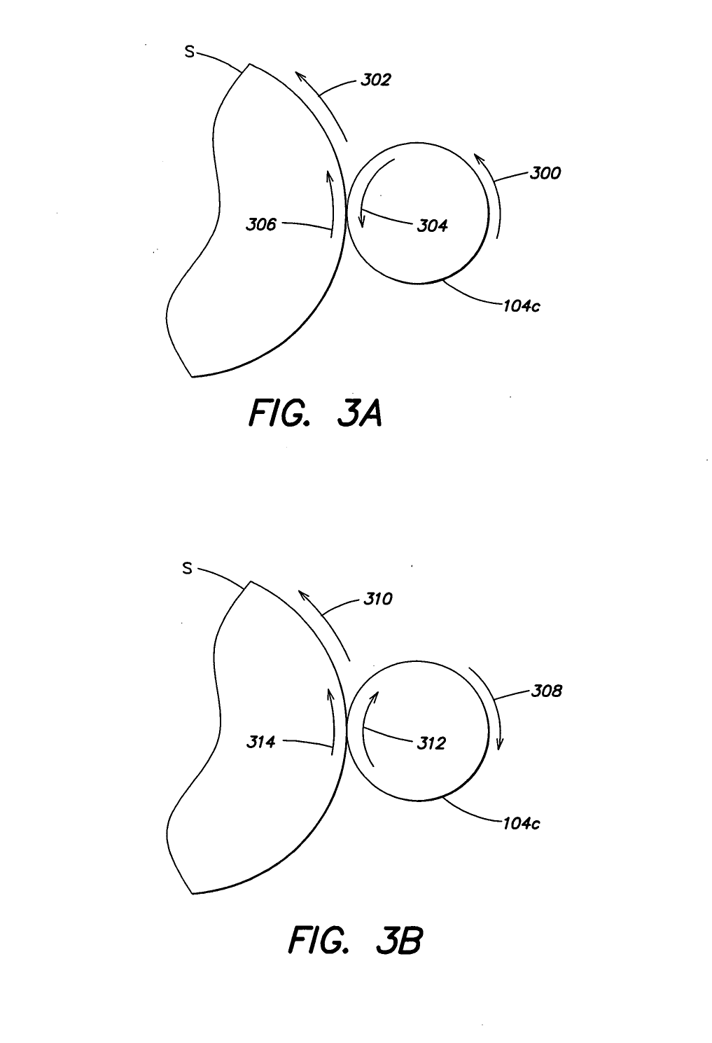

In one embodiment of the invention, the substrate S and the rollers 104a-d are rotated in the same direction. For example, FIG. 3A illustrates a top view of the roller 104c in contact with the substrate S during cleaning wherein the substrate S and roller 104c rotate in the same direction as indicated by arrows 300 and 302. When the rollers 104a-d and substrate S rotate in the same direction, the tangential velocities of the rollers 104a-d and the substrate S are in opposite directions as shown by arrows 304 and 306 in FIG. 3A, producing a large frictional force between each roller 104a-d and the substrate S at their point of contact.

In another embodiment of the invention, the substrate S and the rollers 104a-d are rotated in opposite directions. For example, FIG. 3B illustrates a top view of the roller 104c in contact with the substrate S during cleaning wherein the substrate S and roller 104c rotate in opposite directions as indicated by arrows 308 and 310. When the rollers 104a-d and substrate S rotate in opposite directions, the tangential velocities of the rollers 104a-d and the substrate S are in the same direction as shown by arrows 312 and 314. Accordingly, the difference in tangential speed of the rollers 104a-d and the substrate S at their point of contact determines the frictional force generated between the rollers 104a-d and the substrate S.

FIGS. 4A and 4B illustrate a top view and a side view, respectively, of a second exemplary edge cleaning apparatus 400 provided in accordance with the present invention. With reference to FIGS. 4A and 4B, the second edge cleaning apparatus 400 includes a substrate support 402 (FIG. 1B) adapted to support, but not actively rotate, a substrate S. The second cleaning apparatus 400 further includes a first plurality of drive rollers 404a-c positioned to contact and rotate the substrate S, and at least one additional cleaning roller 405 that has a larger radius than the drive rollers 404a-c (as described further below). While three drive rollers 404a-c are shown in FIGS. 4A-4B, it will be understood that fewer or more drive rollers may be used (e.g., 1, 2, 4, 5, 6, etc., drive rollers). Likewise, more cleaning rollers may be used (e.g., 2, 3, 4, etc., cleaning rollers).

In the embodiment of FIGS. 4A and 4B, the substrate support 402 is not rotated/driven by a motor. However, the substrate support 402 may rotate freely, such as under the influence of the drive rollers 404a-c. Each drive roller 404a-c is shown as each being rotated/driven by a separate motor 408a-c, and the cleaning roller 405 is shown as being rotated/driven by a motor 409. In another embodiment, each of the drive rollers 404a-c and the cleaning roller 405 may be driven by the same motor. For example, FIG. 4C is a front view of the second edge cleaning apparatus 400 in which a single motor 408 drives each roller 404a-c, 405 (via a plurality of belts 410a-d coupled to respective shafts 412a-d of each roller, only two of which are shown in FIG. 1C). Note that such an implementation is less expensive and easier to implement.

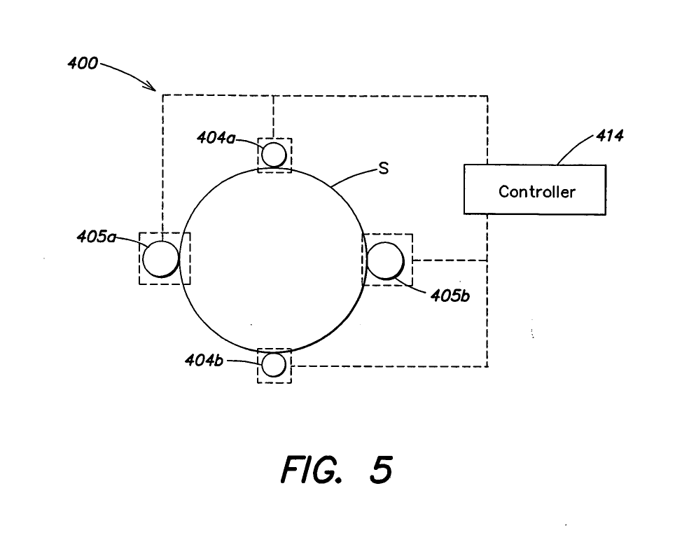

As stated, more than one cleaning roller 405 may be employed by the second cleaning apparatus 400. For example, FIG. 5 is top view of an embodiment in which the second cleaning apparatus 400 employs two drive rollers 404a-b and two cleaning rollers 405a-b. Other numbers of drive rollers and/or cleaning rollers may be used.

With reference again to FIGS. 4A-5, the second edge cleaning apparatus 400 may include a controller 414 that is adapted to control operation of the second edge cleaning apparatus 400. For example, the controller 414 may be coupled to the motors 408a-c, 409 (or the motor 408 in the embodiment of FIG. 4C) and direct rotation of the drive rollers 404a-c and the cleaning roller 405 as described further below. The controller 414 may include one or more microprocessors, microcontrollers, logic circuitry, a combination of the same, or any suitable hardware and/or software for controlling operation of the second edge cleaning apparatus 400.

In at least one embodiment of the invention, the cleaning roller(s) 405 may be adapted to move along the edge of the substrate S to more effectively clean the substrate S as described previously with reference to FIG. 2A and the roller 104a. Likewise, one or more stationary cleaning rollers may be positioned so as to clean the top bevel of the substrate S and/or the bottom bevel of the substrate S as previously described with reference to the rollers 104c′, 104c″ of FIG. 2A. In one embodiment, at least one cleaning roller may be positioned to clean an outer edge of the substrate S, at least one cleaning roller may be positioned to clean a top bevel of the substrate S and at least one cleaning roller may be positioned to clean a bottom bevel of the substrate S (see FIG. 2A).

Each cleaning roller 405 may have any shape suitable for cleaning the edge region of the substrate S. For example, each cleaning roller 405 may have a flat surface similar to the flat surface 208 of the roller 104a shown in FIG. 2B; or a grooved surface similar to the grooved surface 210 of the roller 104a shown in FIG. 2C. A flat surface may be more effective at cleaning the outer edge of the substrate S, while a grooved surface may be more effective at cleaning the beveled edges of the substrate S. Any other roller shapes may be used for the drive rollers 404a-c and/or the cleaning roller(s) 405, as may combinations of roller shapes.

The cleaning roller(s) 405 may be formed from any material that effectively cleans the edge of the substrate S. For example, if a cleaning chemistry is to be employed during edge cleaning, a soft roller material such as polyvinyl acetate (PVA) or the like may be used for one or more of the cleaning rollers 405. However, if edge cleaning is to be predominately friction based (e.g., polishing), a harder roller material such as a fixed abrasive (e.g., a diamond impregnated polymer or metal matrix or another fixed abrasive), silicon carbide, etc., may be used for one or more of the cleaning rollers 405. The drive rollers 404a-c may be formed from polyeurethane, rubber or any other suitable material.

In at least one embodiment of the invention, the drive rollers 404a-c have a diameter of about 1-5 inches, and the cleaning rollers 405 have a diameter of about 2-10 inches. Other drive and/or cleaning roller sizes may be used. In other embodiments, each cleaning roller may have a smaller size than the drive rollers.

In operation, to clean the edge of the substrate S, the substrate S is placed on the substrate support 402 as shown in FIGS. 4A-4C. For example, the substrate S may be held against the substrate support 402 by vacuum, an electrostatic potential or by any other suitable chucking technique. In some embodiments, the substrate S may not be chucked by the substrate support 402, and may be allowed to move laterally relative to the substrate support 402. In still other embodiments, the substrate support 402 may be eliminated (e.g., the rollers 404a-c and/or 405 may support the substrate S). Note that the rollers 404a-c, 405 may be retracted during placement of the substrate S onto the substrate support 402, and then brought into contact with the substrate S (as shown). The controller 414 may be adapted to control substrate placement and/or retraction of the rollers 404a-c, 405.

Once the substrate S has been placed on and held by the substrate support 402, the controller 414 may direct the motors 408a-c (or 408 in FIG. 4C) to rotate the rollers 404a-c so as to rotate the substrate S. Such rotation may occur before, during or after each cleaning roller(s) 405 contact(s) the substrate S. In one embodiment, a substrate rotation rate of about 5 to 100 rotations per minute (RPM), and in one embodiment about 50 RPM, may be used for a 300 mm substrate. Other rotation rates may be used.

Before, during or after the substrate S begins to rotate, the controller 414 may direct the motor 409 (or the motor 408 in FIG. 1C) to rotate each cleaning roller 405. In one embodiment, a cleaning roller rotation rate of about 1 to 500 rotations per minute (RPM) may be used for a 300 mm substrate. For example, the same rotation rate may be used for the drive and cleaning rollers as described further below. Other rotation rates may be used. In at least one embodiment, a positive pressure, such as less than 20 psi, may be exerted against the substrate S by the rollers 104a-d. Other pressures may be used.

The rotation rates and/or directions of the substrate S and the rollers 404a-c, 405 are selected such that at the point (or points) of contact between each cleaning roller 405 and the substrate S, each cleaning roller 405 and the substrate S have a different tangential velocity. In this manner, sliding contact occurs between each cleaning roller 405 and the substrate S, and the edge of the substrate S is cleaned (e.g., by mechanical polishing or by chemically assisted polishing if a cleaning chemistry is employed). Cleaning may continue until any material to be removed from the edge of the substrate S has been removed.

In one embodiment of the invention, the drive rollers 404a-c and the cleaning roller(s) 405 are rotated in opposite directions such that the substrate S and the cleaning roller(s) 405 are rotated in the same direction (in a manner similar to that shown in FIG. 3A with reference to the roller 104c). When the cleaning roller(s) 405 and substrate S rotate in the same direction, the tangential velocities of the cleaning roller(s) 405 and the substrate S are in opposite directions (see arrows 304 and 306 in FIG. 3A), producing a large frictional force between each cleaning roller 405 and the substrate S at their point of contact.

In another embodiment of the invention, the drive rollers 404a-c and the cleaning roller(s) 405 are rotated in the same direction such that the substrate S and the cleaning roller(s) 405 are rotated in opposite directions (in a manner similar to that shown in FIG. 3B with reference to the roller 104c). When the cleaning roller(s) 405 and substrate S rotate in opposite directions, the tangential velocities of the cleaning roller(s) 405 and the substrate S are in the same direction at the point of contact between the cleaning roller(s) 405 and the substrate S (see arrows 312 and 314 in FIG. 3B). Accordingly, the difference in tangential speed of the cleaning roller(s) 405 and the substrate S at their point of contact determines the frictional force generated between the cleaning roller(s) 405 and the substrate S. Because the drive rollers 404a-c and the cleaning roller(s) 405 have different diameters, the drive rollers 404a-c and cleaning roller(s) 405 may be rotated at the same speed (and in the same direction) and still produce different tangential velocities for the substrate S and the cleaning roller(s) 405 at the point of contact therebetween. Accordingly, the implementation of such an embodiment is simplified since a single motor may be employed to drive the drive rollers 404a-c and the cleaning roller(s) 405.

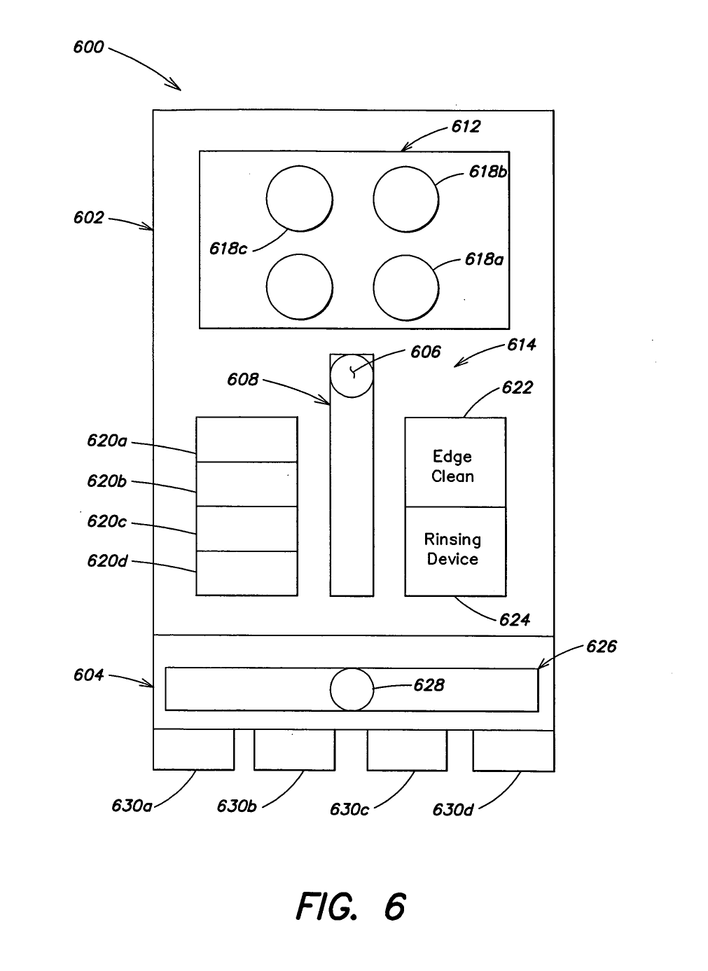

FIG. 6 is a top plan view of an exemplary embodiment of a planarization system 600. The planarization system 600 includes a processing subsystem 602 coupled to a factor interface 604. The processing subsystem 602 may be similar to a Mirra Mesa™ planarization system manufactured by Applied Materials, Inc. (e.g., a 200 mm substrate planarization tool) and described in U.S. patent application Ser. No. 09/547,189, filed Apr. 11, 2000 and titled “METHOD AND APPARATUS FOR TRANSFERRING SEMICONDUCTOR SUBSTRATES USING AN INPUT MODULE”, which is hereby incorporated by reference herein in its entirety, or another similar system.

The processing subsystem 602 includes a robot 606 that is movable along a track 608, an input shuttle (not separately shown), a polishing system 612 and a cleaning system 614. The polishing system 612 includes a load cup (not separately shown), a first polishing platen 618a (e.g., a bulk polishing platen), a second polishing platen 618b (e.g., an endpoint on barrier layer polishing platen) and a third polishing platen 618c (e.g., a barrier layer buff polishing platen). The cleaning system 614 includes an input module 620a, a megasonic module 620b, a scrubber module 620c, and an output module 620d. Other types of polishing platens and/or cleaning techniques/arrangements may be employed.

The processing system 602 also includes an edge cleaning module 622 and a rinsing device 624. The edge cleaning module 622 may include any of the edge cleaning apparatus described herein with reference to FIGS. 1A-5. The rinsing device 624 may include, for example, a spin rinse dryer or similar rinsing device.

Factory interface 604 includes a buffer chamber 626, a substrate handler 628 located within the buffer chamber 626 and a plurality of loadports 630a-d coupled to the buffer chamber 626. In general, any number of substrate handlers and/or loadports may be employed within the factory interface 604, and other configurations may be used.

In operation, a cassette of substrates may be placed on one of the loadports 630a-d, and the substrate handler 628 may extract a substrate from the cassette. The substrate handler 628 then may transfer the substrate to the robot 606, and the robot 606 may deliver the substrate to the polishing system 612. After the substrate has been polished within the polishing system 612, the robot 606 may transfer the substrate to the input module 620a, and the substrate may be cleaned using the megasonic module 620b and/or scrubber module 620c. Thereafter, the robot 606 may transfer the substrate to the edge cleaning apparatus 622 and edge/bevel cleaning may be performed as described previously with reference to FIGS. 1A-5. Following edge cleaning, the substrate may be transferred to and cleaned within the rinsing device 624 and returned to a substrate cassette via the robot 606 and/or the substrate handler 628.

The foregoing description discloses only exemplary embodiments of the invention. Modifications of the above disclosed apparatus and method which fall within the scope of the invention will be readily apparent to those of ordinary skill in the art. For instance, the present invention may be employed to remove slurry residue from substrate edges, as well as photoresist or other pre-formed and/or pre-deposited films or layers.

While the present invention has been described as employing one or more rollers to clean and/or polish material from the bevel and/or edge region of a substrate, a fixed abrasive material, such as a fixed abrasive tape, also may be employed to contact an edge of a substrate as the substrate is rotated (e.g., whether the substrate is rotated by a substrate support, one or more drive rollers or another mechanism). In one embodiment, a stationary fixed abrasive such as a fixed abrasive tape may be indexed (e.g., moved up or down relative to a horizontal substrate or moved to the right or left relative to a vertical substrate) so as to introduce new fixed abrasive material during cleaning of a substrate and/or during cleaning of subsequent substrates. For example, after a pre-determined number of substrates have been cleaned, the fixed abrasive tape may be moved so as to introduce new fixed abrasive material to the edge of substrates to be cleaned. Indexing may be periodic and/or on an as-need basis.

Accordingly, while the present invention has been disclosed in connection with exemplary embodiments thereof, it should be understood that other embodiments may fall within the spirit and scope of the invention, as defined by the following claims.

The invention claimed is:

1. An apparatus for cleaning an edge of a substrate comprising:
a substrate support adapted to support and rotate a substrate; and
one or more rollers positioned to contact an edge of a substrate supported by the substrate support and to clean the edge of the substrate as the substrate support rotates the substrate relative to the one or more rollers.

2. The apparatus of claim 1 wherein the substrate support comprises a vacuum chuck or an electrostatic chuck adapted to hold the substrate.

3. The apparatus of claim 1 wherein the one or more rollers have the same diameter.

4. The apparatus of claim 1 wherein the one or more rollers are driven by a first motor.

5. The apparatus of claim 4 wherein the substrate support is driven by the first motor.

6. The apparatus of claim 4 wherein the substrate support is driven by a second motor.

7. The apparatus of claim 1 wherein each roller is driven by a separate motor.

8. The apparatus of claim 1 wherein the substrate support and the one or more rollers are adapted to rotate in the same direction.

9. The apparatus of claim 1 wherein the substrate support and the one or more rollers are adapted to rotate in opposite directions.

10. The apparatus of claim 1 wherein at least one of the rollers is adapted to move so as to clean a top bevel and a bottom bevel of the substrate.

11. The apparatus of claim 1 wherein at least one of the rollers is angled relative to a major surface of the substrate.

12. An integrated substrate cleaning system comprising:
a housing having:
the edge cleaning apparatus of claim 1;
a substrate rinsing apparatus; and
a substrate transport device adapted to transport substrates between the edge cleaning apparatus and the substrate rinsing apparatus.

13. An apparatus for cleaning an edge of a substrate comprising:
one or more rollers of a first diameter adapted to contact an edge of a substrate and rotate the substrate; and
one or more rollers of a second diameter that is larger than the first diameter adapted to contact the edge of the substrate and to clean the edge of the substrate;

14. The apparatus of claim 13 wherein the one or more rollers of the first diameter and the one or more rollers of the second diameter are adapted to rotate at substantially the same speed.

15. The apparatus of claim 13 further comprising a substrate support adapted to support the substrate.

16. The apparatus of claim 13 wherein each roller is driven by a first motor.

17. The apparatus of claim 13 wherein each roller is driven by a separate motor.

18. The apparatus of claim 13 wherein the one or more rollers of the first diameter and the one or more rollers of the second diameter are adapted to rotate in the same direction.

19. The apparatus of claim 13 wherein the one or more rollers of the first diameter and the one or more rollers of the second diameter are adapted to rotate in opposite directions.

20. The apparatus of claim 13 wherein at least one of the rollers of the second diameter is adapted to move so as to clean a top bevel and a bottom bevel of the substrate.

21. The apparatus of claim 13 wherein at least one of the rollers of the second diameter is angled relative to a major surface of the substrate.

22. An integrated substrate cleaning system comprising:
a housing having:
the edge cleaning apparatus of claim 13;
a substrate rinsing apparatus; and
a substrate transport device adapted to transport substrates between the edge cleaning apparatus and the substrate rinsing apparatus.
